(19) United States
(12) Patent Application Publication
(10) Pub. No.: US 2015/0304865 A1
(43) Pub. Date: Oct. 22, 2015

(54) QUALITY OF SERVICE MONITORING FOR INTERNET PROTOCOL BASED COMMUNICATION SERVICE

(71) Applicant: TELEFONAKTIEBOLAGET L M ERICSSON (PUBL), Stockholm (SE)

(72) Inventor: Jens POSCHER, Aachen (DE)

(73) Assignee: TELEFONAKTIEBOLAGET L M ERICSSON (PUBL), Stockholm (SE)

(21) Appl. No.: 14/439,027

(22) PCT Filed: Oct. 30, 2012
(86) PCT No.: PCT/EP2012/071493

§ 371 Date: Apr. 28, 2015

(51) Int. Cl. H04W 24/08; H04W 76/02; H04W 24/10

(52) U.S. Cl. CPC H04W 24/08; H04W 24/10; H04W 76/02

(57) ABSTRACT

In a method monitoring quality of service (QoS) of an IP based communication service, a node for controlling the IP service receives a request for initiating a session of the IP service. The node sends a request authorizing the session to a policy controller, and sends an indication to the policy controller that QoS monitoring is required for the session. The policy controller determines a policy rule for identifying and controlling user plane traffic of the session and sends an indication of the policy rule to a gateway node. The policy controller also sends an indication to the gateway node that QoS monitoring is required for the identified user plane traffic. The gateway node monitors QoS of the identified user plane traffic, and sends a QoS report indicating the QoS to the policy controller. The policy controller forwards the QoS report to the node for controlling the IP service.

### TECHNICAL FIELD

The present invention relates to methods for traffic monitoring in a telecommunications network and to corresponding devices.

### BACKGROUND

In telecommunications networks, e.g., in cellular networks as specified by 3GPP (3rd Generation Partnership Project), communication services may be provided on the basis of Internet Protocol (IP) transport channels to a user equipment (UE). One example of such communication services is a voice call established through infrastructure of the network referred to as IP Multimedia Subsystem (IMS). In this case, an IMS node referred to as Proxy Call Session Control Function (P-CSCF) may interact with IP based transport infrastructure of the network, e.g., referred to as Evolved Packet Core (EPC) so as to provide IP based bearers for carrying user plane traffic of the voice call to or from the UE. As for example defined in 3GPP Technical Report 21.905, such bearers may be regarded as an information transmission path having defined characteristics, such as capacity, delay, bit error rate, or the like. Other IP based communication services which may be provided through the IMS are voice call services, video call services, chat services, and mobile TV services.

However, for such IP based communication services there exist only limited possibilities of monitoring Quality of Service (QoS), e.g., using generic counters in base stations or nodes of the EPC. Detailed knowledge on the QoS for IP based communication services may in turn be beneficial for ensuring a certain QoS level, fault analysis, or network optimization or improving user experience.

Accordingly, there is a need for techniques which allow for efficiently monitoring the QoS for an IP based communication service.

### SUMMARY

According to an embodiment of the invention, a method of traffic monitoring in a telecommunications network is provided. According to the method, a node for controlling an IP based communication service receives request for initiating a session of the IP based communication service. Further, the node sends a request for authorizing the session to a policy controller of the telecommunications network. The node also sends an indication to the policy controller that QoS monitoring is required for the session. From the policy controller, the node receives a QoS report. The QoS report indicates the monitored QoS for the session.

According to a further embodiment of the invention, a method of traffic monitoring in a telecommunications network is provided. According to the method, a policy controller of the telecommunications network receives, from a node for controlling an IP based communication service, a request for authorizing a session of the IP based communication service. The policy controller also receives an indication from the node that QoS monitoring is required for the session. Further, the policy controller determines at least one policy rule for identifying and controlling user plane traffic of the session. The policy controller sends an indication of the at least one policy rule to a gateway node of the telecommunications network. The policy controller also sends an indication to the gateway node that QoS monitoring is required for the identified user plane traffic. From the gateway node, the policy controller receives a QoS report. The QoS report indicates the monitored QoS. The policy controller forwards the QoS report to the node for controlling the IP based communication service.

According to a further embodiment of the invention, a method of traffic monitoring in a telecommunications network is provided. According to the method, a gateway node of the telecommunications network receives, from a policy controller of the telecommunications network, an indication of at least one policy rule for identifying and controlling user plane traffic of a session of an IP based communication service. The gateway node also receives an indication from the policy controller that QoS monitoring is required for the identified user plane traffic. Further, the gateway node monitors QoS of the identified user plane traffic and generates a QoS report. The QoS report indicates the monitored QoS. The gateway node sends the QoS report to the policy controller.

According to a further embodiment of the invention, a node for controlling an IP based communication service in a telecommunications network is provided. The node comprises a first interface for session control signalling of an IP based communication service, a second interface with respect to a policy controller of the telecommunications network, and a processor. The processor is configured to:
receive, via the first interface, a request for initiating a session of the IP based communication service,
send, via the second interface and to the policy controller, a request for authorizing the session,
send, via the second interface and to the policy controller, an indication that QoS monitoring is required for the session, and
receive, via the second interface and from the policy controller, a QoS report, the quality of service report indicating the monitored QoS.

According to a further embodiment of the invention, a policy controller for a telecommunications network is provided. The policy controller comprises a first interface with respect to a node for controlling an IP based communication service, a second interface with respect to a gateway node of the telecommunications network, and a processor. The processor is configured to:
receive, via the first interface and from the node for controlling the IP based communication service, a request for authorizing a session of the IP based communication service,
receive, via the first interface and from the node for controlling the IP based communication service, an indication that QoS monitoring is required for the session,
determine a policy rule for identifying and controlling user plane traffic of the session,
send, via the second interface and to the gateway node, an indication of the at least one policy rule,
send, via the second interface and to the gateway node, an indication that QoS monitoring is required for the identified user plane traffic,
receive, via the second interface and from the gateway node, a QoS report, the QoS report indicating the monitored QoS, and
forward the QoS report via the first interface to the node for controlling the IP based communication service.

According to a further embodiment of the invention, a gateway node for a telecommunications network is provided. The gateway node comprises a first interface with respect to a policy controller of the telecommunications network, a second interface for transmitting user plane traffic, and a processor. The processor is configured to:
receive, via the first interface and from the policy controller, an indication of at least one policy rule for identifying and controlling user plane traffic of a session of an IP based communication service,
receive, via the first interface and from the policy controller, an indication that QoS monitoring is required for the identified user plane traffic,
monitor QoS of the identified user plane traffic transmitted via the second interface, and
generate a QoS report indicating the monitored QoS and send the QoS report via the first interface to the policy controller.

According to a further embodiment of the invention, a system for traffic monitoring in a telecommunications network is provided. The system comprises a node for controlling an IP based communication service, a policy controller, and a gateway node. The node for controlling the IP based communication service, the policy controller, and/or the gateway node may be configured according to the above embodiments of the invention. The node for controlling the IP based communication service may be configured to receive a request for initiating a session of the IP based communication service, to send a request for authorizing the session to the policy controller, and to send an indication to the policy controller that QoS monitoring is required for the session. The policy controller may be configured to determine a policy rule for identifying and controlling user plane traffic of the session, and to send to the gateway node an indication of the policy rule and an indication that QoS monitoring is required for the identified user plane traffic. The gateway node may be configured to monitor QoS of the identified user plane traffic, to generate a QoS report indicating the monitored QoS, and to send the QoS report to the policy controller. The policy controller may be configured to forward the QoS report to the node for controlling the IP based communication service.

According to a further embodiment of the invention, a computer program product is provided. The computer program product comprises computer readable program code that, when executed by a processor of a node for controlling an IP based communication service in a telecommunications network, causes the node to carry out the steps of a method comprising:
receiving a request for initiating a session of the IP based communication service,
sending, to a policy controller of the telecommunications network, a request for authorizing the session,
sending, to the policy controller, an indication that QoS monitoring is required for the session, and
receiving a QoS report from the policy controller, the QoS report indicating the monitored QoS for the session.

According to a further embodiment of the invention, a computer program product is provided. The computer program product comprises computer readable program code that, when executed by a processor of a policy controller of a telecommunications network, causes the policy controller to carry out the steps of a method comprising:
receiving, from a node for controlling an IP based communication service, a request for authorizing a session of the IP based communication service, receiving, from the node for controlling the IP based communication service, an indication that QoS monitoring is required for the session,
determining at least one policy rule for identifying and controlling user plane traffic of the session,
sending an indication of the at least one policy rule to a gateway node of the telecommunications network,
sending, to the gateway node, an indication that QoS monitoring is required for the identified user plane traffic,
receiving a QoS report from the gateway node, the QoS report indicating the monitored QoS, and
forwarding the QoS report to the node for controlling the IP based communication service.

According to a further embodiment of the invention, a computer program product is provided. The computer program product comprises computer readable program code that, when executed by a processor of a gateway node of a telecommunications network, causes the gateway node to carry out the steps of a method comprising:
receiving, from a policy controller of the telecommunications network, an indication of at least one policy rule for identifying and controlling user plane traffic of a session of an IP based communication service,
receiving, from the policy controller, an indication that QoS monitoring is required for the identified user plane traffic,
monitoring QoS of the identified user plane traffic, and
generating a QoS report indicating the monitored QoS and sending the QoS report to the policy controller.

### BRIEF DESCRIPTION OF THE DRAWINGS

FIG. 1 schematically illustrates a cellular network architecture in which concepts according to an embodiment of the invention may be implemented.

FIG. 2 schematically illustrates implementation of concepts according to an embodiment of the invention in an exemplary policy control architecture.

FIG. 3 show an exemplary signaling diagram for illustrating procedures according to an embodiment of the invention.

FIG. 4 shows a flowchart for illustrating a method according to an embodiment of the invention.

FIG. 5 shows a flowchart for illustrating a further method according to an embodiment of the invention.

FIG. 6 shows a flowchart for illustrating a further method according to an embodiment of the invention.

FIG. 7 shows a communication control node according to an embodiment of the invention.

FIG. 8 schematically illustrates a policy controller according to an embodiment of the invention.

FIG. 9 schematically illustrates a gateway node according to an embodiment of the invention.

### DETAILED DESCRIPTION OF EMBODIMENTS

In the following, concepts in accordance with exemplary embodiments of the invention will be explained in more detail by to the accompanying drawings. The illustrated embodiments relate to concepts for traffic monitoring in a 3GPP LTE (Long Term Evolution) cellular network. However, it is to be understood that the illustrated concepts may be applied in other types of telecommunications network as well. The concepts in particular have the purpose of supporting QoS monitoring for IP based communication services, such as IP based voice call services, video call services, chat services, and/or mobile TV services.

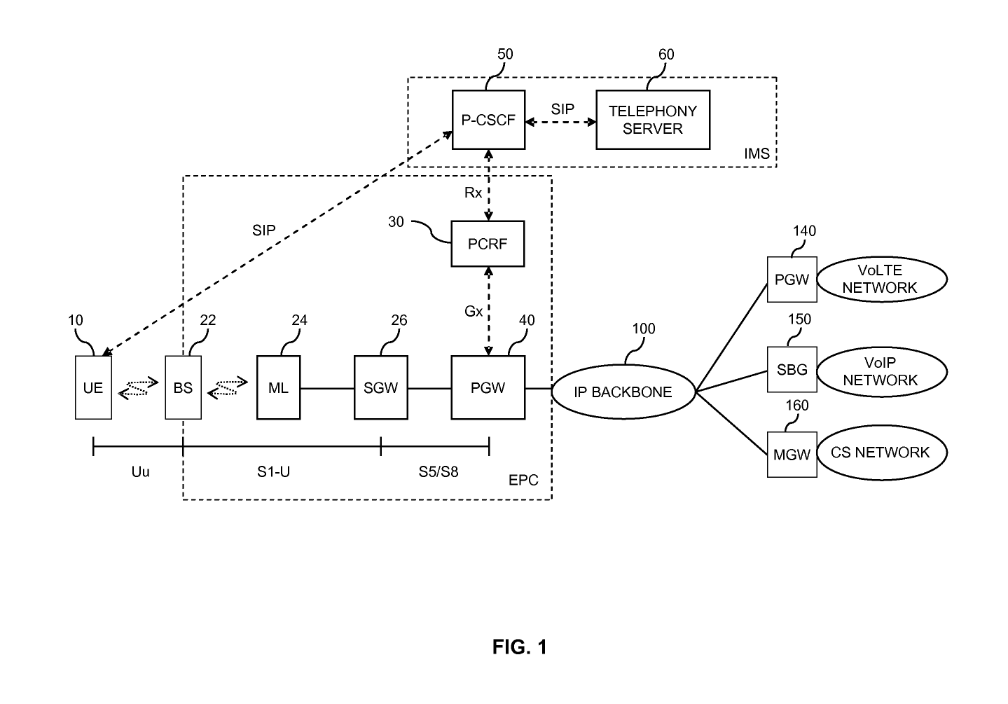

For purposes of illustrating the concepts, an architecture for supporting IP based communication services as illustrated in FIG. 1 is assumed, which includes IMS and EPC infrastructure. As illustrated, the EPC infrastructure includes a base station (BS) 22 for establishing a radio connection to a UE 10, gateway nodes 26, 40 for carrying user plane traffic of the UE 10, and a policy controller 30. In accordance with the illustrated LTE scenario, the base station 22 may implement an evolved Node B (eNB), the gateway node 26 may implement a Serving Gateway (SGW), the gateway node 40 may implement a Packet Data Network Gateway (PGW), and the policy controller 30 may implement a Policy and Charging Rules Function (PCRF). In the illustrated example, the EPC infrastructure also includes a radio unit 24, referred to as mini link (ML), coupled between the base station 22 and the gateway node 26, thereby allowing for using a radio link for providing a backhaul connection of the base station 22. Alternatively, also a wire based direct or indirect connection could be provided between the base station 22 and the gateway node 26.

Between the gateway node 40 and the gateway node 26 user plane traffic of the UE 10 is carried over an IP based interface referred to as S5/S8. Between the gateway node 26 and the base station 22, the user plane traffic of the UE 10 is carried over an IP based interface referred to as S1-U. This traffic is forwarded transparently through the radio unit 24 or other intermediate IP based transport nodes. Between the base station 22 and the UE 10, the user plane traffic of the UE 10 is carried over an IP based radio interface, referred to as Uu. The gateway node 40 communicates with the policy controller 30 via a control plane interface referred to as Gx. Details concerning typical characteristics and functionalities of the Gx interface can for example be found in the 3GPP Technical Specification (TS) 23.203 and 29.212.

The gateway node 40 is coupled via an IP backbone 100 to external network nodes, e.g., an external PGW 140 for implementing IP based communication services with UEs in other LTE network sites, a Session Border Gateway (SBG) 150 implementing IP based communication services with endpoints in some other type of IP based network, and a Media Gateway (MGW) 160 for implementing IP based communication services connecting to terminals in a Circuit Switched (CS) network.

The IMS infrastructure includes a node 50 for controlling the IP based communication services. In the illustrated examples, the node 50 is implemented as a P-CSCF. The node 50 may provide session or call control functionalities such as performing control functionalities for handling IP based communication service sessions towards the EPC infrastructure. Further, the IMS infrastructure may include various types of application servers for providing particular IP based communication services. In FIG. 1, a telephony server 60 is illustrated as an example of such application servers. The telephony server 60 may for example support IP based voice and/or video calls. For initiating a session of such IP based communication service, session control signalling between the node 50 and the UE 10 and/or between the node 50 and such application server, e.g., the telephony server 60, may be used. Such session control signalling may for example be based on the Session Initiation Protocol (SIP). The node 50 communicates with the policy controller 30 via a control plane interface referred to as Rx. Details concerning typical characteristics and functionalities of the Rx interface can for example be found in the 3GPP TS 23.203, 29.212, and 29.214.

As can be seen, in this architecture communication services such as voice calls, video calls, chat, or mobile TV may be implemented using IP based transport mechanisms for conveying media to or from the UE 10 and through the cellular network. However, as can be seen from the example of IP based communication services implemented via the external MGW 160, such IP based communication service may also provide a connection to a remote terminal located in the CS domain.

According to the illustrated concepts, QoS monitoring for an IP based communication service is controlled on a session level by the node 50. For this purpose, the node 50 is provided with functionalities for indicating via the Rx interface to the policy controller 30 that QoS monitoring for a session of an IP based communication service is required. This may for example be accomplished in connection with initially authorizing the session by the policy controller 30.

The policy controller 30 is provided with functionalities for indicating via the Gx interface to the gateway node 40 that QoS monitoring is required for the user plane traffic of the session. This may be accomplished in connection with providing one or more PCC rules for the session to the gateway node 40.

The gateway node 40 is provided with functionalities for performing the QoS monitoring on the user plane traffic transmitted through the gateway node 40 and to generate a corresponding QoS report. The PCC rules may be used by the gateway node 40 for identifying the user plane traffic to be monitored, e.g., using one or more packet filters defined by the PCC rules which operate on the basis of an source and/or destination addresses, and/or source and/or destination port numbers of data packets, e.g., as defined for the Transport Control Protocol (TCP) or User Datagram Protocol (UDP), in the user plane traffic through the gateway node 40. Further, deep packet inspection (DPI) functionalities of the gateway node 40 may be used for identifying the user plane traffic of the session. In this way, QoS monitoring may be accomplished in an efficient manner on a per-session basis.

The QoS monitoring may involve determining QoS parameters which reflect the user experience, e.g., voice and/or video quality or responsiveness of communication. Such monitored QoS parameters may be updated and stored by the gateway node 40 until the QoS report is generated from the monitored QoS parameters. Examples of such QoS parameters which can be monitored by the gateway node 40 are a packet loss number, jitter, and/or packet delay. The gateway node 40 may apply various suitable procedures for determining such QoS parameters. By way of example, for determining the packet loss number, the gateway node 40 may identify packet losses on the basis of sequence numbers in the data packets of the user plane traffic of the session, e.g., sequence numbers as included in data packets of the Realtime Transport Protocol. For determining jitter, the gateway node 40 may measure the timing of received data packets of the user plane traffic of the session, e.g., relative to a reference timing such as a synchronous timing reference representing the nominal packet timing of a media codec used for the session. For example, the nominal packet timing for the Adaptive Multi-Rate (AMR) audio codec may be 200 ms. For measuring packet delay, timestamps included in the data packets of the user plane data traffic of the session may be evaluated.

The QoS report generated by the gateway node 40 is sent via the Gx interface to the policy controller 30 and then forwarded by the policy controller 30 to the node 50 via the Rx interface. This can be accomplished at the end of the session, in response to a trigger such as a request for the QoS report, or in regular time intervals.

The node 50 may provide the QoS report or information derived therefrom to other nodes, e.g., for performance analysis and/or business support statistics. For example, information from the QoS report could be analyzed on a per-user basis, depending on the remote endpoint of the session, depending on the type of terminal of the UE 10, or the like. For analysis purposes, it may also be useful to average or otherwise combine information from multiple QoS reports for different sessions. The QoS report or information derived therefrom could also be added to a Charging Detail Records (CDR) so as to be available for later processing. Further, the node may utilize information from the QoS report for controlling admission of further sessions of the same or other IP based communication services. For example, if analysis reveals that the QoS level for a certain type of remote endpoints is insufficient, the node 50 may refuse or delay admission of a further session with such endpoint. After a certain time, a further session may be admitted again and the QoS monitored to check if the QoS level is now sufficient.

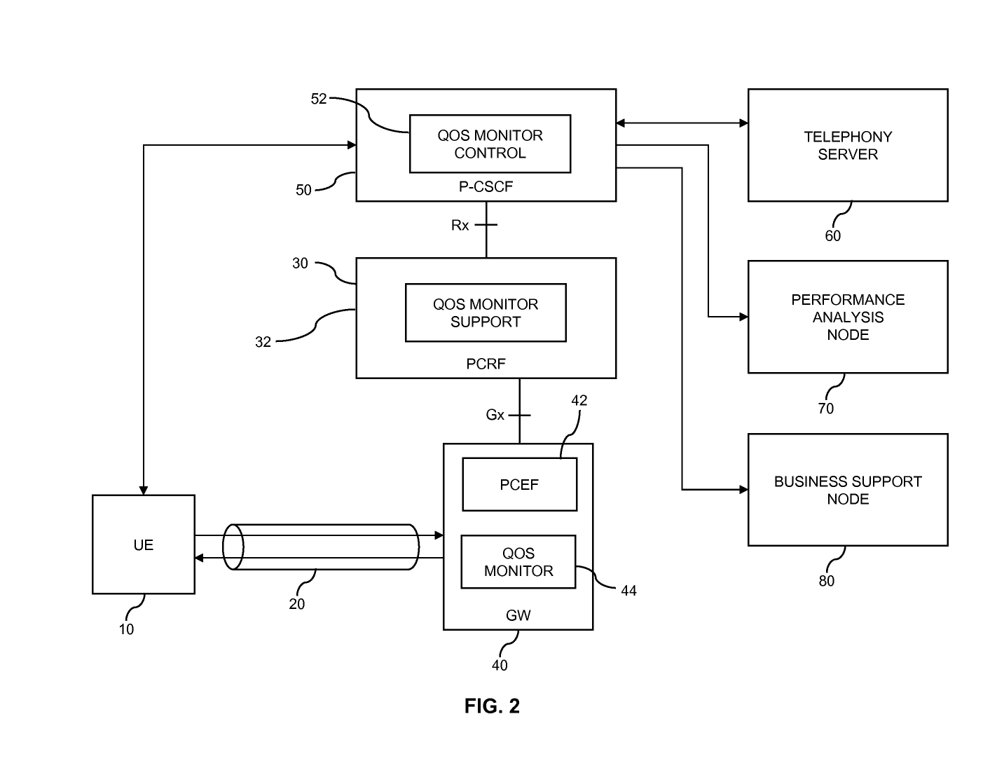

FIG. 2 illustrates implementation of the concepts when assuming a policy and charging control (PCC) architecture according to 3GPP TS 23.203. In particular, FIG. 2 further illustrates corresponding functionalities as implemented at the node 50, assumed to implement a P-CSCF, at the policy controller 30, assumed to implement a PCRF, and the gateway node 40, assumed to implement a PGW. As illustrated, the node 50 implements a QoS monitor control 52, the policy controller implements a QoS monitor support, and the gateway node 40 implements a Policy Control Enforcement Function (PCEF) 42 and a QoS Monitor 44. The policy controller 30 may perform policy control decision and/or flow based charging control. The policy controller 30 may also provide network control regarding detection of service data flows detection, gating, QoS, and/or flow based charging towards the PCEF 42. For this purpose, the policy controller 30 may signal policy rules, in 3GPP TS 23.203 referred to as PCC rules, to the PCEF 42. The PCEF 42 may perform service data flow detection, policy enforcement and flow based charging functionalities, which is typically accomplished by applying the PCC rules as signaled by the policy controller 30. Further, the PCEF 42 may also implement functionalities of packet inspection, such as DPI, and service classification. In this way data packets may be classified according to PCC rules defined in the PCEF 42 and be assigned to a certain service. As mentioned above, such functionalities may be efficiently utilized for identifying the user plane traffic of the session for which QoS monitoring needs to be performed.

Further, FIG. 2 illustrates additional nodes 70, 80 to which the node 50 may provide the QoS report(s) or information derived therefrom. In the illustrated example, these nodes include a performance analysis node 70 and a business support node 80. The performance analysis node 70 may utilize the QoS information from the node 50 for further analyzing performance of the IP based communication service and collect and/or report results of such analysis to still further nodes or systems. The business support node 80 may use the QoS information from the node 50 and typically also CDR information for fault analysis or network optimization.

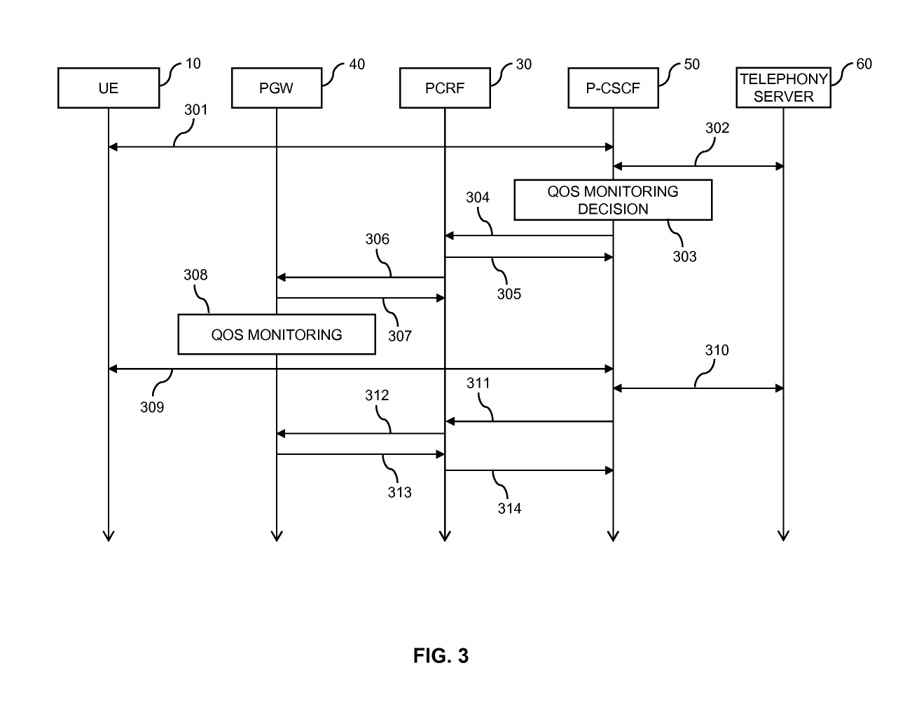

In the following, the above concepts will be further explained by referring to exemplary procedures as illustrated in FIG. 3. The procedures of FIG. 3 relate to establishing and terminating an IMS voice call. However, it should be understood that similar procedures could also be applied to sessions of other IP based communication services such as IMS video calls, IMS chats, or IMS mobile TV sessions. The procedures of FIG. 3 involve the UE 10, the gateway node (PGW) 40, the policy controller (PCRF) 30, the node (P-CSCF) 50, and the telephony server 60. For other types of IP based communication services the telephony server 60 could be replaced by another type of application server.

In the procedures of FIG. 3, session control signalling 301, 302 between the UE 10 and the P-CSCF 50 and/or between the telephony server 60 and the P-CSCF 50 may be used for initiating setup of the IMS voice call. In this process, the telephony server 60 may for example determine legs of the IMS voice call needed to form a user plane traffic connection between the UE 10 and the remote endpoint of the IMS voice call. The session control signalling 301, 302 may be based on SIP and be used for requesting establishment of the IMS voice call from the P-CSCF 50. The signalling 301, 302 towards the P-CSCF 50 may include information concerning the IMS voice call to be established, e.g., concerning a remote endpoint of the IMS voice call. Such information may be conveyed using the Session Description Protocol (SDP).

The P-CSCF 50 may then decide whether QoS monitoring should be performed for this IMS voice call or not, as indicated by QoS monitoring decision 303. The QoS monitoring decision may for example be based on information received through the signalling 301 or 302, e.g., on SDP information. For example, the P-CSCF 50 may decide that QoS monitoring should be performed for all IMS voice calls carried over an LTE connection, also referred to as Voice over LTE (VoLTE) calls, or for a certain statistically relevant percentage of such IMS voice calls. The P-CSCF 50 may also decide that QoS monitoring should be performed for IMS voice calls to or from a certain connected network in which the remote endpoint is located, e.g., networks connected via the PGW 140, SGB 150, or MGW 160 of FIG. 1. For example, such connected networks could be identified by an appropriately defined IP sub-network mask covering remote endpoints in the VoIP network connected via the SBG 150 or remote endpoints in the CS network connected via the MGW 160. The P-CSCF 50 could also decide that QoS monitoring should be performed for IMS voice calls using a specific media codec, e.g., as defined in the received SDP information.

The P-CSCF 50 may then proceed by sending a request 304 for authorizing the IMS voice call to the PCRF 30. The request 304 may be an initial Authentication/Authorization Request (AAR) command of the Diameter based protocol implemented on the Rx interface between the P-CSCF 50 and the PCRF 30. The request 304 typically includes information describing the session for which authorization is requested, e.g., type of service, IP address of the UE 10, codec data, or the like. The request 304 may include such information in Attribute Value Pairs (AVPs) as defined in 3GPP TS 29.214.

Further, the P-CSCF 50 uses the request 304 for indicating to the PCRF 30 whether QoS monitoring is required for the IMS voice call being established. In the illustrated example, it is assumed that the P-CSCF 50 decided that QoS monitoring should be performed for the present IMS voice call. Accordingly, request 304 includes an indication that QoS monitoring is required. This indication may be included in a further AVP of request 304.

The PCRF 30 may then perform an authorization check and respond to the request 304 by sending message 305 to the P-CSCF 50. Message 305 may be an Authentication/Authorization Answer (AAA) command of the Diameter based protocol implemented on the Rx interface between the P-CSCF 50 and the PCRF 30. In the illustrated example, it is assumed that the PCRF 30 authorizes the IMS voice call as described by the information in the request 304 and uses message 305 to indicate this authorization to the P-CSCF 50.

The PCRF 30 then proceeds by determining one or more PCC rules for the IMS voice call. For this purpose, the PCRF 30 may utilize information from the request 304, but also other information available to the PCRF 30, e.g., from a subscriber database or the like. The PCC rules have the purpose of configuring the PGW 40 to identify and suitably control user plane traffic of the IMS voice call, e.g., by providing a bearer for carrying user plane traffic of the IMS voice call and applying packet filters and/or DPI for directing the user plane traffic to this bearer.

By sending message 306 to the PGW 40, the PCRF 30 indicates the PCC rules to the PGW 40. This may involve sending data for installing the PCC rules to the PGW 40. Further, the PCC rules may also be preconfigured in the PGW 40 and be activated by the indication. Message 306 may be a Re-Authorization Request (RAR) command of the Diameter based protocol implemented on the Gx interface between the PCRF 30 and the PGW 40, and the PCC rules may be indicated by corresponding AVPs of the message 306, e.g., as defined in 3GPP TS 29.212. As described in 3GPP TS 29.212, the RAR command may be used in for unsolicited provisioning of PCC rules to the PCEF 42. In the PGW 40, the PCEF 42 may use the PCC rules for identifying and controlling the user plane traffic of the IMS voice call, e.g., by applying packet filters and/or DPI for directing the user plane traffic to the desired bearer. The PGW 40 may also perform further procedures for setting up or configuring the bearer over the S5/S8, S1-U, and Uu interfaces as illustrated in FIG. 1. This may involve control plane signalling with the SGW implemented by gateway node 26, control plane signalling with the BS 22, or control plane signalling with an Mobility Management Entity (MME).

In the illustrated example, message 306 is further used for providing an indication to the PGW 40 that QoS monitoring is required for the user plane traffic of the IMS voice call as identified by the PCC rules. This indication may be included in a further AVP of message 306.

Having setup or configured the bearer and installed or activated the indicated PCC rules, the PGW 40 indicates this by sending message 307 to the PCRF 30. The Message 307 may be a Re-Authorization Answer (RAA) command of the Diameter based protocol implemented on the Gx interface between the PCRF 30 and the PGW 40.

As illustrated by step 308, the PGW 40 may then perform QoS monitoring of the user plane data traffic of the IMS voice call. For this purpose, the PGW 40 may inspect the user plane data traffic of the UE 10 and identify the user plane traffic pertaining to the IMS voice call in accordance with the PCC rules indicated by the PCRF 30. This monitoring may be accomplished on uplink and/or downlink user plane traffic of the IMS voice call. A differentiation between uplink and downlink QoS monitoring is also possible if QoS parameters pertaining to downlink only or QoS parameters pertaining to uplink only are of interest. The monitored QoS parameters may for example include packet delay, a packet loss number, and/or jitter. Other parameters relevant for QoS analysis could be measured as well. The PGW 40 regularly updates and stores the monitored QoS parameters for reporting. For example, such QoS parameters could be stored in a table having entries for multiple ongoing IMS voice calls having user plane traffic routed through the PGW 40.

At some point, as indicated by session control signalling 309 between the P-CSCF 50 and the UE 10 and session control signalling 310 between the P-CSCF 50 and the telephony server 60, the IMS voice call may be terminated. By sending message 311 to the PCRF 30, the P-CSCF 50 indicates termination of the IMS voice call to the PCRF 30. Message 311 may be an update AAR command or a Session Termination Request (STR) command of the Diameter based protocol implemented on the Rx interface between the P-CSCF 50 and the PCRF 30.

Upon receiving message 311, the PCRF 30 requests the PCEF 42 to modify the previously indicated PCC rules. In particular, the PCRF 30 sends message 312 to the PGW to request removal of the PCC rules for the IMS voice call. Message 312 may be a RAR command of the Diameter based protocol implemented on the Gx interface between the PCRF 30 and the PGW 40 and utilize the Charging Rule Remove AVP as described in 3GPP TS 29.212.

The PCEF 42 in the PGW 40 then removes the PCC rules for the IMS voice call and release the bearer provided for the IMS voice call. The PCEF 42 in the PGW 40 may confirm removal of the PCC rules by sending message 313 to the PCRF 30. Message 313 may be a RAA command of the Diameter based protocol implemented on the Gx interface between the PCRF 30 and the PGW 40.

At this point, the PGW 40 also generates a QoS report for the IMS voice call from the monitored and stored QoS parameters and sends the QoS report to the PCRF 30. In the illustrated example, message 313 is utilized for this purpose. In particular, the QoS report may be included in a further AVP of message 312.

Upon receiving the QoS report from the PGW 40, the PCRF 30 forwards the QoS report to the P-CSCF 50. This is accomplished by sending message 314 to the P-CSCF 50. In the illustrated example, message 314 is a response of the PCRF 30 to message 311 indicating termination of the IMS voice call. Message 314 may be a Session Termination Answer (STA) command of the Diameter based protocol implemented on the Rx interface between the P-CSCF 50 and the PCRF 30. The QoS report may be included in a further AVP of message 314. In the illustrated example, the PCRF 30 may delay sending the response to message 311 until the QoS report is received from the PGW 40, which allows for efficiently using the response in message 314 also for forwarding the QoS report.

In the procedures of FIG. 3, the QoS reporting is triggered at termination of the IMS voice call. However, other triggers for QoS reporting could be used alternatively or in addition. For example, the P-CSCF 50 could request the QoS report at any time during the IMS voice call, e.g., if problems with other IMS voice calls are detected. This could be accomplished by sending a message with a corresponding indication to the PCRF 30, e.g., an update AAR command including the request for the QoS report in a further AVP. The PCRF 30 may then request the QoS report from the PGW 40 by sending a message with a corresponding indication to the PGW 40, e.g., an RAR command including the request for the QoS report in a further AVP. The PGW 40 may include the QoS report in a response to this message, e.g., in a further AVP of an RAA command, and the PCRF 30 may forward the QoS report in a response to the message from the P-CSCF 50 indicating the request for the QoS report, e.g., in a further AVP of an AAA command.

The QoS reporting could also be triggered at the PCRF 30 or at the PGW 40. Further, also QoS reporting at regular time intervals during the IMS voice call may be utilized. For example, the P-CSCF 50 may subscribe to such regular reporting by including a corresponding indication in message 304, and the PCRF 30 may regularly obtain QoS reports from the PGW 40, e.g., by using regular QoS report requests in RAR commands and receiving the QoS reports in the RAA commands returned in response by the PGW 40. Alternatively, the PCRF 30 could also subscribe to regular QoS reporting by the PGW 40 by including a corresponding indication in message 306, and the PGW 40 could then regularly generate and send QoS reports to the PCRF 30, e.g., by including the QoS report in a further AVP of an update Credit Control Request (CCR) command of the Diameter based protocol implemented on the Gx interface between the PCRF 30 and the PGW 40. Regular QoS reporting from the PCRF 30 to the P-CSCF 50 could be accomplished by including the QoS report in a further AVP of an update RAR command of the Diameter based protocol implemented on the Rx interface between the PCRF 30 and the P-CSCF 50. Such regular QoS reporting may also be activated later during the IMS voice call, e.g., by including a corresponding indication in an update AAR command from the P-CSCF 50 to the PCRF 30 or in an update RAR command from the PCRF 30 to the PGW 40.

A CCR command on the Gx interface may also be used for sending a QoS report to the PCRF 30 when QoS reporting is locally triggered at the PGW 40. Similarly, a RAR command on the Rx interface may also be used for forwarding a QoS report to the P-CSCF 50 when QoS reporting is locally triggered at the PCRF 30.

The P-CSCF 50 may use the QoS report(s) obtained via the PCRF 30 from the PGW 40 in various ways. In some implementations, the P-CSCF 50 may utilize information from the QoS report(s) for performing admission control for new IMS voice calls. For example, the P-CSCF 50 might reject new IMS voice calls if such information indicates that the QoS level for a certain category of IMS voice calls, e.g., defined in terms of network location of the remote endpoint, is not sufficient. For this purpose, a corresponding threshold could be defined per category of IMS voice calls. The node could also make the information available to any performance analysis system or Operations and Maintenance System (OSS), e.g., as represented by the performance analysis node 70, or in CDRs, e.g., as utilized by the business support node 80. The P-CSCF 50 may actively send the information to such other nodes, e.g., in the case of the performance analysis node 70, or may passively allow access to the information by such other nodes, e.g., in the case of the business support node 80.

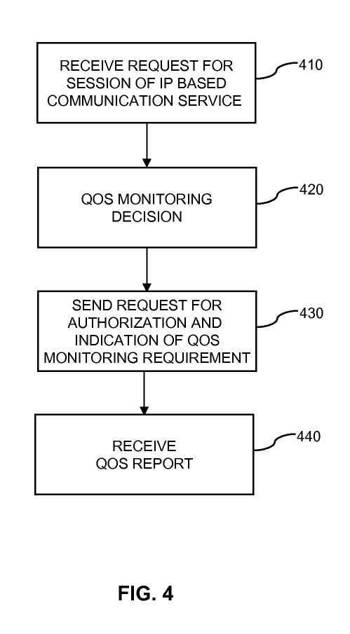

FIG. 4 shows a flowchart for illustrating a method of traffic monitoring which may be used for implementing the above concepts in a node for controlling an IP based communication service in a telecommunications network, e.g., in the above-mentioned node 50 implementing a P-CSCF. The IP based communication service may for example be an IP based voice call service, an IP based video call service, an IP based chat service, or IP based mobile TV service, e.g., as provided by the IMS. The node may also control a plurality of such IP based communication services.

At step 410, the node receives a request for initiating a session of the IP based communication service. The request may for example be received from a UE forming an endpoint of the session, e.g., from the UE 10, or from some other node such as an application server, e.g. the telephony server 60. The UE may initiate the session or may be invited to the session by the remote endpoint. The request of step 410 may for example be an SIP request.

At step 420, the node may determine whether QoS monitoring is required for the session, i.e., perform a QoS monitoring decision as for example described in connection with step 303 of FIG. 3. This determination may be based on a network address of a remote endpoint of the session, e.g., depend on the different types of connected networks (VoLTE networks, other VoIP networks, CS networks) as illustrated in FIG. 1, because depending on the type of connected network the remote endpoint of the session will be associated with a different IP address. Subnet masks may also be used for distinguishing between categories of remote endpoints. The determination may also be based on a media codec used for the session, e.g., as indicated in the request of step 410. In this way, QoS monitoring could be activated for types of media codecs which are more susceptible to QoS degradation.

At step 430, the node sends a request for authorizing the session to a policy controller of the telecommunications network. The policy controller may for example correspond to the above-mentioned policy controller 30 implementing a PCRF. Further, the node sends an indication to the policy controller that QoS monitoring is required for the session. The indication of the QoS monitoring requirement may also specify further details of the required QoS monitoring, e.g., QoS parameters to be monitored and/or a way of reporting the monitored QoS. The node may send the indication in response to determining that QoS monitoring is required for the session, i.e., in accordance with the QoS monitoring decision of step 420. The request and the indication may be transmitted over a control-plane interface between the node and the policy controller, e.g., the above-mentioned Rx interface. The request and the indication may be transmitted in the same message. For example, the request may be an AAR command of the Diameter based protocol implemented on the Rx interface, and the indication may be included in a further AVP of the AAR command. Alternatively, the request and the indication may be transmitted in separate messages, e.g., in an initial AAR command and a later update AAR command for the same session.

At step 440, the node receives a QoS report from the policy controller. The QoS report indicates the monitored QoS for the session. The QoS report may be received via the control-plane interface which was also used for sending the request and indication at step 430, e.g., the Rx interface. Various procedures may be used for efficiently receiving the QoS report. In some cases, the node may send a message indicating termination of the session to the policy controller, e.g., an update AAR command or STR command over the Rx interface. The node may then receive the QoS report in a response to the message indicating termination of the session, e.g., in an AAA command or STA command over the Rx interface. Further, the node may also send an explicit request for the QoS report to the policy controller, e.g., in an update AAR command over the Rx interface, and receive the QoS report in response to this request, e.g., in an AAA command over the Rx interface. Various triggers at the node may be used to initiate requesting of the QoS report, e.g., a need to establish a further session of the IP based communication service. The node may also subscribe to regular QoS reporting by the policy controller, e.g., in an AAR command over the Rx interface, and receive QoS reports in regular time intervals, e.g., in RAR commands over the Rx interface.

The node may then use the QoS report in various ways. For example, the node may provide the QoS report or information derived therefrom to at least one further node of the telecommunications network, e.g., to the above-mentioned performance analysis node 70 or business support node 80. For this purpose, the node may actively send the QoS report or derived information to the further node or may passively allow access to the QoS report or derived information by the further node. The node may also utilize the monitored QoS as a basis for controlling admission of a further session of the IP based communication service. In this way, if the monitored QoS indicates an insufficient QoS level, the further session could be rejected or delayed until the QoS level has improved.

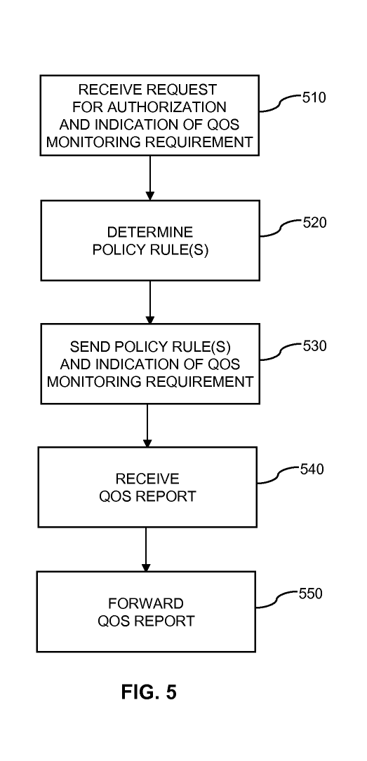

FIG. 5 shows a flowchart for illustrating a method which may be used for implementing the above concepts in a policy controller of a telecommunications network, e.g., in the above-mentioned policy controller 30 implementing a PCRF.

At step 510, the policy controller receives a request for authorizing a session of an IP based communication service from a node of the telecommunications network which controls this IP based communication service, e.g., from the above-mentioned node implementing a P-CSCF. The IP based communication service may for example be an IP based voice call service, an IP based video call service, an IP based chat service, or IP based mobile TV service, e.g., as provided by the IMS. The node may also control a plurality of such IP based communication services.

Further, the policy controller receives from the node an indication that QoS monitoring is required for the session. The indication of the QoS monitoring requirement may also specify further details of the required QoS monitoring, e.g., QoS parameters to be monitored and/or a way of reporting the monitored QoS. The request and the indication may be transmitted over a control-plane interface between the node and the policy controller, e.g., the above-mentioned Rx interface. The request and the indication may be transmitted in the same message. For example, the request may be an AAR command of the Diameter based protocol implemented on the Rx interface, and the indication may be included in a further AVP of the AAR command. Alternatively, the request and the indication may be transmitted in separate messages, e.g., in an initial AAR command and a later update AAR command for the same session.

At step 520, the policy controller determines at least one policy rule for identifying and controlling user plane traffic of the session, e.g., a PCC rule as described above. For these purposes, the at least one policy rule may define one or more packet filters for directing the user plane traffic of the session to a bearer offering a desired QoS.

At step 530, the policy controller sends an indication of the at least one policy rule to a gateway node of the telecommunications network, e.g., the above-mentioned gateway node 40 implementing a PGW. The gateway node carries the user plane traffic of a UE participating in the session of the IP based communication service. The user plane traffic may for example be based on RTP/UDP/IP encapsulated media data. Further, the policy controller sends an indication to the gateway node that quality of service monitoring is required for the user plane traffic as identified by the policy rule. The indication of the QoS monitoring requirement may also specify further details of the required QoS monitoring, e.g., QoS parameters to be monitored and/or a way of reporting the monitored QoS. The at least one policy rule and the QoS monitoring requirement may be indicated over a control-plane interface between the node and the policy controller, e.g., the above-mentioned Gx interface. The at least one policy rule and the QoS monitoring requirement may be indicated in the same message. For example, the at least one policy rule may be indicated in an RAR command of the Diameter based protocol implemented on the Gx interface, and the indication may be included in a further AVP of the RAR command. Alternatively, the at least one policy rule and the QoS requirement may be indicated in separate messages, e.g., in separate RAR commands for the same session.

At step 540, the policy controller receives a QoS report from the gateway node. The QoS report indicates the monitored quality of service. The QoS report may be received via the control-plane interface which was also used at step 530 for sending the at least one policy rule and indication to the gateway node, e.g., the Gx interface. Various procedures may be used for efficiently receiving the QoS report. In some cases, the policy controller may send a request for modification of the at least one policy rule to the gateway, e.g., a request for removal of the at least one policy rule. The request may for example be an RAR command of the Diameter based protocol implemented on the Gx interface. The policy controller may then receive the QoS report in a response to this request for modification of the at least one policy rule. This response may for example be a RAA command of the Diameter based protocol implemented on the Gx interface. In some cases, the policy controller may also receive the QoS report in a message indicating a loss of bearer or some other event detected by the gateway node, e.g., in a CCR command over the Gx interface. Further, the policy controller may send an explicit request for the QoS report to the gateway node, e.g., in an RAR command over the Gx interface, receive the QoS report in response to this request, e.g., in a RAA command over the Gx interface. Various triggers at the policy controller may be used to initiate requesting of the QoS report from the gateway node. The policy controller may also subscribe to regular QoS reporting by the gateway node, e.g., in an RAR command over the Gx interface, and receive QoS reports in regular time intervals, e.g., in CCR commands over the Gx interface.

At step 550, the policy controller forwards the QoS report to the node controlling the IP based communication service. The QoS report may be forwarded via the control-plane interface which was also used for receiving the request and indication at step 510, e.g., the Rx interface. Various procedures may be used for efficiently forwarding the QoS report. In some cases, the policy controller may receive a message indicating termination of the session from the node controlling the IP based communication service, e.g., an update AAR command or STR command over the Rx interface. The policy controller may then forward the QoS report in a response to the message indicating termination of the session. In such cases, the policy controller may delay the response to said message indicating termination of the session until the policy controller has received the quality of service report from the gateway node, e.g., as explained in connection with messages 311 and 314 of FIG. 3.

Further, the policy controller may also receive an explicit request for the QoS report from the node controlling the IP based communication service, e.g., in an AAR command over the Rx interface, and obtain and forward the QoS report in response to this request, e.g., in an AAA command over the Rx interface. The node may also have subscribed to regular QoS reporting by the policy controller, e.g., in an AAR command over the Rx interface, and the policy controller may obtain and forward QoS reports in regular time intervals, e.g., in RAR commands over the Rx interface. Various triggers at the policy controller may be used to initiate obtaining and forwarding of the QoS report.

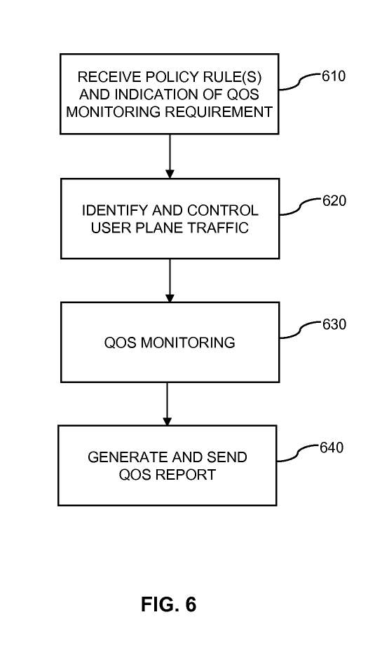

FIG. 6 shows a flowchart for illustrating a method which may be used for implementing the above concepts in a gateway node of a telecommunications network, e.g., in the above-mentioned gateway node 40 implementing a PGW. The gateway node carries the user plane traffic of a UE participating in a session of an IP based communication service. The user plane traffic may for example be based on RTP/UDP/IP encapsulated media data.

At step 610, the gateway node receives an indication of at least one policy rule, e.g., a PCC rule as described above. The indication of the at least one policy rule is received from a policy controller of the telecommunications network, e.g., the above-mentioned policy controller 30 implementing a PCRF.

Further, the gateway node receives an indication from the policy controller that quality of service monitoring is required for the user plane traffic as identified by the policy rule. The indication of the QoS monitoring requirement may also specify further details of the required QoS monitoring, e.g., QoS parameters to be monitored and/or a way of reporting the monitored QoS. The at least one policy rule and the QoS monitoring requirement may be indicated over a control-plane interface between the policy controller and the gateway node, e.g., the above-mentioned Gx interface. The at least one policy rule and the QoS monitoring requirement may be indicated in the same message. For example, the at least one policy rule may be indicated in an RAR command of the Diameter based protocol implemented on the Gx interface, and the QoS monitoring requirement may be included in a further AVP of the RAR command. Alternatively, the at least one policy rule and the QoS monitoring requirement may be indicated in separate messages, e.g., in separate RAR commands for the same session.

As indicated by step 620, the at least one policy rule may be used by the gateway node for identifying and controlling user plane traffic of the session of the IP based communication service. For these purposes, the at least one policy rule may define one or more packet filters for directing the user plane traffic of the session to a bearer offering a desired QoS.

At step 630, the gateway node performs QoS monitoring on the identified user plane traffic. For this purpose the gateway node may utilize the at least one policy rule for identifying the user plane traffic to be monitored, e.g., by filtering and/or inspecting data packets of the user plane traffic through the gateway node in accordance with the at least one policy rule. The QoS monitoring may involve measuring and storing one or more QoS parameters, e.g., a packet loss number, jitter, and/or delay.

At step 640, the gateway node generates a QoS report indicating the monitored QoS and sends the QoS report to the policy controller. For this purpose, the stored QoS parameters of step 630 may be aggregated to a suitable format. Also, certain QoS parameters of interest may be selected.

The gateway node may send the QoS report via the control-plane interface which was also used at step 610 for receiving the indication of the at least one policy rule and the indication of the QoS monitoring requirement, e.g., the Gx interface. Various procedures may be used for efficiently sending the QoS report. In some cases, the policy controller may send a request for modification of the at least one policy rule to the gateway, e.g., a request for removal of the at least one policy rule. The request may for example be an RAR command of the Diameter based protocol implemented on the Gx interface. The gateway node may then send the QoS report in a response to this request for modification of the at least one policy rule. This response may for example be a RAA command of the Diameter based protocol implemented on the Gx interface. Further, the gateway node may receive an explicit request for the QoS report from the policy controller, e.g., in an RAR command over the Gx interface, and send the QoS report in response to this request, e.g., in a RAA command over the Gx interface. The policy controller may also have subscribed to regular QoS reporting by the gateway node, e.g., in an RAR command over the Gx interface, and the gateway node may send QoS reports in regular time intervals, e.g., in CCR commands over the Gx interface. Various triggers at the gateway node may be used to initiate sending of the QoS report to the policy controller, e.g., a loss of the bearer for transmitting the user plane traffic. In response to such a trigger, the gateway node may send the QoS report in a CCR command over the Gx interface.

As can be seen, the methods of FIGS. 4, 5, and 6 may be combined with each other in a system which includes the node controlling the IP based communication service, the policy controller, and the gateway node. In particular, the method of FIG. 4 may be used for providing the request and indication of QoS monitoring requirement received as inputs in step 510 of the method of FIG. 5, and the method of FIG. 5 may be used for providing the QoS report received as input in step 440 of the method of FIG. 4. Alternatively or in addition, the method of FIG. 5 may be used for providing the indication of policy rule(s) and indication of QoS monitoring requirement received as inputs in step 610 of the method of FIG. 6, and the method of FIG. 6 may be used for providing the QoS report received as input in step 440 of the method of FIG. 5.

Combining the methods of FIGS. 4, 5, and 6 may result in a method in which the node for controlling the IP based communication service receives a request for initiating a session of the IP based communication service and sends a request for authorizing the session to the policy controller, and in which the node for controlling the IP based communication service also sends an indication to the policy controller that QoS monitoring is required for the session, e.g., as part of the request for authorizing the session. In such method the policy controller determines a policy rule for identifying and controlling user plane traffic of the session and sends, to the gateway node, an indication of the policy rule and an indication that QoS monitoring is required for the identified user plane traffic, e.g., as part of the indication of the policy rule. The gateway node monitors QoS of the identified user plane traffic, generates a QoS report indicating the monitored QoS and sends the QoS report to the policy controller. The policy controller forwards the QoS report to the node for controlling the IP based communication service. Such method may be implemented by a system for monitoring traffic in a telecommunications network which includes the node for controlling the IP based communication service, the policy controller, and the gateway node.

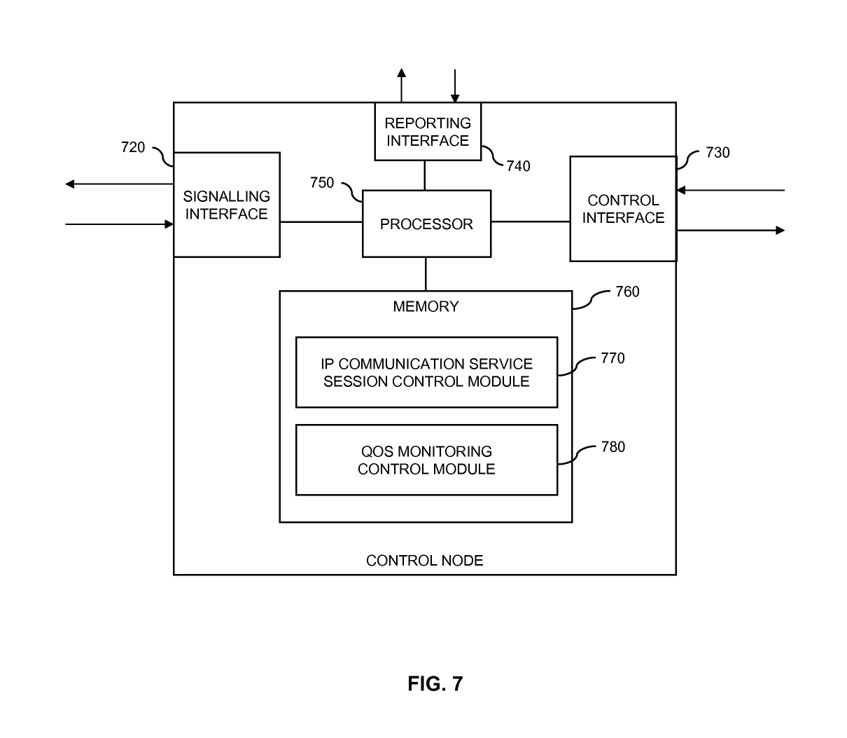

FIG. 7 further illustrates an exemplary implementation of a node for controlling one or more IP based communication services in a telecommunications network. The node of FIG. 7 may for example correspond to the above-mentioned node 50 implementing a P-CSCF.

In the illustrated example, the node includes a signalling interface 720 for performing session control signalling with other nodes or UEs, e.g., SIP based signalling as illustrated by messages 301, 302, 309, 310 of FIG. 3. Further, the node includes a control interface 730 for communication with a policy controller of the telecommunications network, e.g., the above-mentioned policy controller 30 implementing a PCRF. The control interface 730 may in particular implement the above-mentioned Rx interface. Further, the node may include a reporting interface 740 with respect to other nodes such as the performance analysis node 70 or the business support node 80.

Further, the node includes a processor 750 coupled to the interfaces 720, 730, 740 and a memory 760 coupled to the processor 750. The memory 760 may include a read-only memory (ROM), e.g., a flash ROM, a random-access memory (RAM), e.g., a Dynamic RAM (DRAM) or static RAM (SRAM), a mass storage, e.g., a hard disk or solid state disk, or the like. The memory 760 includes suitably configured program code to be executed by the processor 750 so as to implement the above-described functionalities of the node for controlling an IP based communication service. More specifically, the memory 760 may include a IP communication service session control module 770 so as to implement the above-described functionalities for setting up or releasing a session of the IP based communication service, via the signalling interface 720 and the control interface 730. Further, the memory 760 may also include a QoS monitoring control module 780 so as to implement the above described functionalities for indication of the QoS monitoring requirement via the policy controller towards the gateway node and receiving the QoS report from the policy controller, via the control interface 730. The QoS monitoring control module may also handle provision of QoS information from received reports to other nodes, e.g., via the reporting interface 740.

It is to be understood that the structure as illustrated in FIG. 7 is merely schematic and that the policy controller may actually include further components which, for the sake of clarity, have not been illustrated, e.g., further interfaces. Also, it is to be understood that the memory 760 may include further types of program code modules, which have not been illustrated, e.g., program code modules for implementing known functionalities of a P-CSCF. According to some embodiments, also a computer program product may be provided for implementing functionalities of the node, e.g., in the form of a medium storing the program code to be stored in the memory 760.

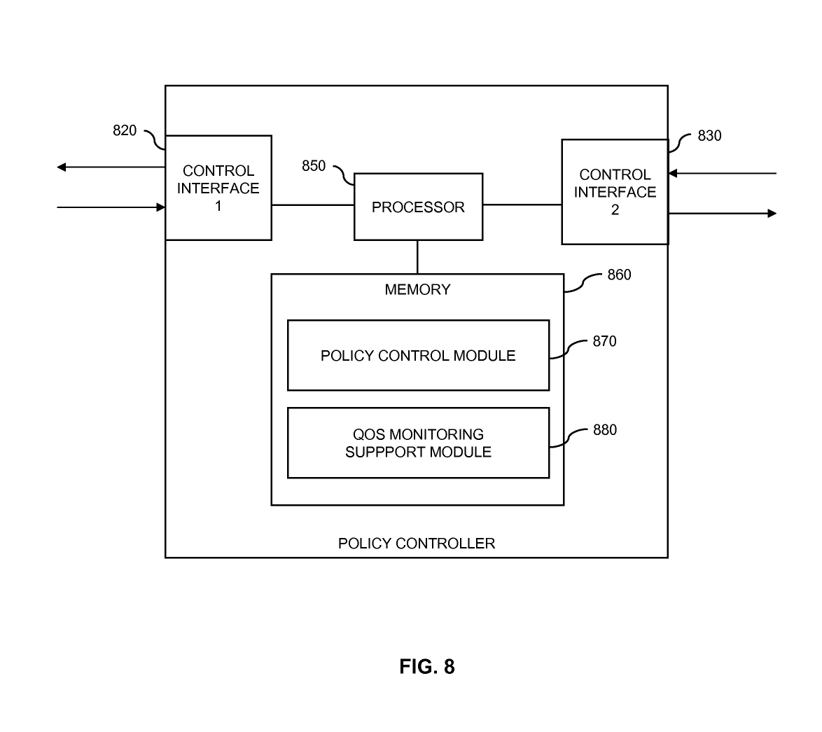

FIG. 8 further illustrates an exemplary implementation of a policy controller of a telecommunications network. The policy controller of FIG. 8 may for example correspond to the above-mentioned policy controller 30 implementing a PCRF.

In the illustrated example, the policy controller includes a first control interface 820 for communication a node for controlling IP based communication services in the telecommunications network, e.g., the above mentioned node 50 implementing a P-CSCF. The first control interface 820 may in particular implement the above-mentioned the Rx interface. Further, the policy controller includes a second control interface 830 for communication with a gateway node, e.g., the above-mentioned gateway node 40 implementing a PGW. The second control interface 830 may in particular implement the above-mentioned the Gx interface.

Further, the policy controller includes a processor 850 coupled to the interfaces 820, 830 and a memory 860 coupled to the processor 850. The memory 860 may include a ROM, e.g., a flash ROM, a RAM, e.g., a DRAM or SRAM, a mass storage, e.g., a hard disk or solid state disk, or the like. The memory 860 includes suitably configured program code to be executed by the processor 850 so as to implement the above-described functionalities of the policy controller. More specifically, the memory 860 may include a policy control module 870 so as to implement the above-described functionalities of controlling, determining and indicating policy rules, using the first and second control interfaces 820, 830. Further, the memory 860 may also include a QoS monitoring support module 880 so as to implement the above described functionalities for forwarding the indication of the QoS monitoring requirement and QoS reports between the node for controlling the IP based communication service and the gateway node, using the first and second control interfaces 820, 830.

It is to be understood that the structure as illustrated in FIG. 8 is merely schematic and that the policy controller may actually include further components which, for the sake of clarity, have not been illustrated, e.g., further interfaces such as an interface with respect to a subscriber database or an interface with respect to charging nodes. Also, it is to be understood that the memory 860 may include further types of program code modules, which have not been illustrated, e.g., program code modules for implementing known functionalities of a PCRF. According to some embodiments, also a computer program product may be provided for implementing functionalities of the policy controller, e.g., in the form of a medium storing the program code to be stored in the memory 860.

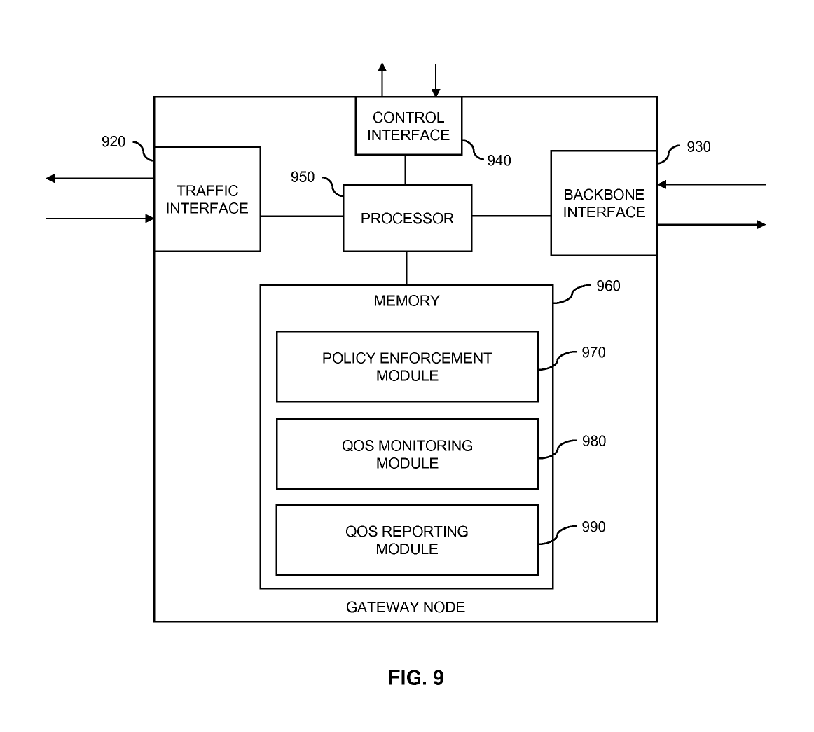

FIG. 9 further illustrates an exemplary implementation of a gateway node of a telecommunications network. The gateway node may be configured to route or process user plane traffic of a UE connected to the telecommunications network, e.g., user plane data traffic of the UE 10. For example, the gateway node correspond to the above-mentioned gateway node 40 implementing a PGW.

In the illustrated example, the gateway node includes a traffic interface 920 for transmitting user plane traffic to or from the UE. The gateway node may also include a backbone interface 930 for transmitting user plane traffic of the UE to or from external networks, e.g., as illustrated by IP backbone 100 of FIG. 1. Further, the gateway node includes a control interface 940 for communication with a policy controller, e.g., the above mentioned policy controller 30 implementing a PCRF. The control interface 940 may correspond to above-mentioned Gx interface.

Further, the gateway node includes a processor 950 coupled to the interfaces 920, 930, 940 and a memory 960 coupled to the processor 950. The memory 960 may include a ROM, e.g., a flash ROM, a RAM, e.g., a DRAM or SRAM, a mass storage, e.g., a hard disk or solid state disk, or the like. The memory 960 includes suitably configured program code to be executed by the processor 950 so as to implement the above-described functionalities of the gateway node. More specifically, the memory 960 may include a policy enforcement module so as to implement the above-described enforcement of policy rules received from the policy controller on user plane traffic carried over the traffic interface 920. Further, the memory 960 may also include a QoS monitoring module 980 so as to implement the above described QoS monitoring of user plane traffic of a session of an IP based communication service. Moreover, the memory may include a QoS reporting module so as to implement the above-described generating and sending of QoS reports via the control interface 940 to the policy controller.

It is to be understood that the structure as illustrated in FIG. 9 is merely schematic and that the gateway node may actually include further components which, for the sake of clarity, have not been illustrated, e.g., further interfaces such as an interfaces to control nodes such as an MME. Also, it is to be understood that the memory 960 may include further types of program code modules, which have not been illustrated, e.g., program code modules for implementing known functionalities of a PCEF, e.g., DPI. According to some embodiments, also a computer program product may be provided for implementing functionalities of the gateway node, e.g., in the form of a medium storing the program code to be stored in the memory 960.

As can be seen, the concepts as described above may be used for efficiently supporting QoS monitoring for an IP based communication service. In particular, the QoS monitoring may be controlled by the same node which also controls the IP based communication service, e.g., the P-CSCF. In this way, valuable QoS information becomes available at the session control plane. Further, the QoS monitoring may be performed on a per-session basis and in a service-aware manner, thereby providing accurate and versatile results. The QoS monitoring may also be implemented efficiently by re-utilizing existing interfaces of the policy controller.

The control node of FIG. 7, the policy controller of FIG. 8, and the gateway node may be used for implementing a system in which the control node of FIG. 7 is configured to receive a request for initiating a session of the IP based communication service, to send a request for authorizing the session to the policy controller, and to send an indication to the policy controller that QoS monitoring is required for the session, e.g., as part of the request for authorizing the session. In such system the policy controller is configured to determine a policy rule for identifying and controlling user plane traffic of the session, to send, to the gateway node, an indication of the policy rule and an indication that QoS monitoring is required for the identified user plane traffic, e.g., as part of the indication of the policy rule. Further, in such system the gateway node is configured to monitor QoS of the identified user plane traffic, generate a QoS report indicating the monitored QoS and send the QoS report to the policy controller. The policy controller is also configured to forward the QoS report to the control node.

It is to be understood that the examples and embodiments as explained above are merely illustrative and susceptible to various modifications. For example, the concepts could be used in various types of telecommunications networks, e.g., combining different types of access technology, including non-cellular broadband access technology. Moreover, it is to be understood that the above concepts may be implemented by using correspondingly designed software to be executed by a processor of an existing device, or by using dedicated device hardware. Still further, it is to be understood that the above-mentioned nodes such as the node for controlling IP based communication services, the policy controller, or the gateway node, may each be implemented by a single device or by multiple devices, e.g., a device cloud or server farm.

1. A method of traffic monitoring in a telecommunications network, the method comprising:
controlling by a node an Internet Protocol based communication service receiving a request for initiating a session of the Internet Protocol based communication service;
sending by the node, to a policy controller of the telecommunications network, a request for authorizing the session;
sending by the node, to the policy controller, an indication that quality of service monitoring is required for the session; and
receiving by the node a quality of service report from the policy controller, said quality of service report indicating the monitored quality of service for the session.

2. The method according to claim 1, wherein said indication that quality of service monitoring is required is comprised in said request for authorizing the session.

3. The method according to claim 2, further comprising:
sending by the node, to the policy controller, a message indicating termination of the session; and
receiving by the node the quality of service report in a response to the message indicating termination of the session.

4. The method according to claim 1, further comprising:
sending by the node, to the policy controller, a request for the quality of service report; and
receiving by the node the quality of service report in response to the request for the quality of service report.

5. The method according to claim 1, further comprising:
providing by the node the quality of service report to at least one further node of the telecommunications network.

6. The method according to claim 1, further comprising:
determining by the node whether quality of service monitoring is required for the session; and
in response to determining that quality of service monitoring is required for the session, sending by the node said indication that quality of service monitoring is required.

7. The method according to claim 6, wherein said determination whether quality of service monitoring is required is based on a network address of a remote endpoint of the session.

8. The method according to claim 6 or 7, wherein said determination whether quality of service monitoring of the service is required is based on a media codec used for the session.

9. The method according to claim 1, further comprising:
on the basis of the monitored quality of service, controlling by the node admission of a further session of the Internet Protocol based communication service.

10. A method of traffic monitoring in a telecommunications network, the method comprising:
receiving by a policy controller of the telecommunications network from a node for controlling an Internet Protocol based communication service, a request for authorizing a session of the Internet Protocol based communication service;
receiving by the policy controller from the node, an indication that quality of service monitoring is required for the session;
determining by the policy controller at least one policy rule for identifying and controlling user plane traffic of the session;
sending by the policy controller an indication of the at least one policy rule to a gateway node of the telecommunications network;
sending by the policy controller to the gateway node, an indication that quality of service monitoring is required for the identified user plane traffic;
receiving by the policy controller a quality of service report from the gateway node, said quality of service report indicating the monitored quality of service; and
forwarding by the policy controller the quality of service report to the node.

11. The method according to claim 10, wherein said indication that quality of service monitoring is required is comprised in said request for authorizing the session.

12. The method according to claim 10, further comprising:
receiving by the policy controller from the node, a message indicating termination of the session; and
forwarding by the policy controller the quality of service report in a response to said message indicating termination of the session.

13. The method according to claim 10, further comprising:
delaying by the policy controller the response to said message indicating termination of the session until the policy controller has received the quality of service report from the gateway node.

14. The method according to claim 10, further comprising:
sending by the policy controller to the gateway node a request for modification of the at least one policy rule; and
receiving by the policy controller the quality of service report in a response to said request for modification of the at least one policy rule.

15. The method according to claim 10, further comprising:
sending by the policy controller a request for the quality of service report to the gateway node; and
receiving by the policy controller the quality of service report in response to the request for the quality of service report.

16. A method of traffic monitoring in a telecommunications network, the method comprising:
receiving by a gateway node of the telecommunications network from a policy controller of the telecommunications network, an indication of at least one policy rule for identifying and controlling user plane traffic of a session of an Internet Protocol based communication service;
receiving by the gateway node from the policy controller, an indication that quality of service monitoring is required for the identified user plane traffic;
monitoring by the gateway node quality of service of the identified user plane traffic; and
generating by the gateway node a quality of service report indicating the monitored quality of service and sending the quality of service report to the policy controller.

17. The method according to claim 16, further comprising:
receiving by the gateway node a request for the quality of service report from the policy controller; and
sending by the gateway node the quality of service report in response to the request for the quality of service report.

18. The method according to claim 16, further comprising:
receiving by the gateway node from the policy controller a request for modification of the at least one policy rule; and
sending by the gateway node the quality of service report in a response to said request for modification of the at least one policy rule.

19. A node for controlling an Internet Protocol based communication service in a telecommunications network, the node comprising:
a first interface for control signalling of the Internet Protocol based communication service;
a second interface with respect to a policy controller of the telecommunications network; and
a processor that is configured to:
receive, via the first interface, a request for initiating a session of the Internet Protocol based communication service,
send, via the second interface and to the policy controller, a request for authorizing the session,
send, via the second interface and to the policy controller an indication that quality of service monitoring is required for the session, and
receive, via the second interface and from the policy controller, a quality of service report, said quality of service report indicating the monitored quality of service.

20. The node according to claim 19, wherein the node further comprises a third interface for providing the quality of service report to at least one further node of the telecommunications network.

21. (canceled)

22. A policy controller for a telecommunications network, the policy controller comprising:
a first interface with respect to a node for controlling an Internet Protocol based communication service;
a second interface with respect to a gateway node of the telecommunications network; and
a processor,
wherein the processor is configured to:
receive, via the first interface and from the node, a request for authorizing a session of the Internet Protocol based communication service,
receive, via the first interface and from the node, an indication that quality of service monitoring is required for the session,
determine a policy rule for identifying and controlling user plane traffic of the session,
send, via the second interface and to the gateway node, an indication of the at least one policy rule,
send, via the second interface and to the gateway node, an indication that quality of service monitoring is required for the identified user plane traffic,
receive, via the second interface and from the gateway node, a quality of service report, said quality of service report indicating the monitored quality of service, and
forward the quality of service report via the first interface to the node.

23. (canceled)

24. A gateway node for a telecommunications network, the gateway node comprising:
a first interface with respect to a policy controller of the telecommunications network;
a second interface for transmitting user plane traffic; and
a processor,
wherein the processor is configured to:
receive, via the first interface and from the policy controller, an indication of at least one policy rule for identifying and controlling user plane traffic of a session of an Internet Protocol based communication service;
receive, via the first interface and from the policy controller, an indication that quality of service monitoring is required for the identified user plane traffic,
monitor quality of service of the identified user plane traffic transmitted via the second interface, and
generate a quality of service report indicating the monitored quality of service and send the quality of service report via the first interface to the policy controller.

25.-26. (canceled)

27. A computer program product comprising a non-transitory computer readable medium storing computer readable program code that, when executed by a processor of a node for controlling Internet Protocol based voice communication in a telecommunications network, causes the node to perform the steps of the method according to claim 1.

28. A computer program product comprising a non-transitory computer readable medium storing computer readable program code that, when executed by a processor of a policy controller of a telecommunications network, causes the policy controller to perform the steps of the method according to claim 10.

29. A computer program product comprising a non-transitory computer readable medium storing computer readable program code that, when executed by a processor of a gateway node of a telecommunications network, causes the gateway node to carry out the steps of the method according to claim 16.
